(19) United States
(12) Patent Application Publication
(10) Pub. No.: US 2014/0325096 A1
(43) Pub. Date: Oct. 30, 2014

(54) DATA MANAGEMENT SYSTEM FOR CONTROLLING A PLURALITY OF PERIPHERALS AND METHOD THEREFOR

(71) Applicants: Intellectual Discovery, Seoul (KR); Vault Micro, Inc., Seoul (KR)

(72) Inventors: Tae Wook JUNG, Goyang-si (KR); Yong Hoon KIM, Osan-si (KR)

(73) Assignees: Intellectual Discovery, Seoul (KR); Vault Micro, Inc., Seoul (KR)

(21) Appl. No.: 14/266,319

(22) Filed: Apr. 30, 2014

(30) Foreign Application Priority Data
Apr. 30, 2013 (KR) 10-2013-0048319
Apr. 30, 2013 (KR) 10-2013-0048324

(51) Int. Cl. G06F 13/12; G06F 11/30

(52) U.S. Cl. CPC G06F 13/126; G06F 11/3051
USPC 710/16

(57) ABSTRACT

The present invention relates to a system and method of data management for controlling a plurality of peripheral devices. In an example embodiment, a data management device for managing data communications between a data control device and the plurality of peripheral devices is added between them, and the data management device controls the plurality of peripheral devices by grouping them according to their characteristics, whereby various protocols can be integrated into minimized optimal protocols by the grouping, and the data control device can reduce technical and temporal overheads due to detection and control of the plurality of peripheral devices.

### CROSS REFERENCE TO RELATED APPLICATIONS

This application claims priority from and the benefit of Korean Patent Application No. 10-2013-0048319, filed on Apr. 30, 2013, and Korean Patent Application No. 10-2013-0048324, filed on Apr. 30, 2013, each of which is incorporated by reference for all purposes as if fully set forth herein.

### BACKGROUND

1. Field

The present invention relates to provisioning of multimedia services, and more specifically to a data management system and method for the same, in which a data management device for managing data communications between a data control device and a plurality of peripheral devices is added between them, and the data management device controls the plurality of peripheral devices by grouping them according to their characteristics, whereby various protocols can be integrated into minimized optimal protocols by the grouping and the data control device can reduce technical and temporal overheads required due to detection and control of the plurality of peripheral devices.

Also, the present invention relates to a data management system and method for the same, in which a data management device for managing data communications between a data control device and a plurality of peripheral devices is added between them, and the data management device virtualizes the plurality of peripheral devices requiring various interfacing manner as standard devices using a standard interfacing manner, whereby the data control device can control the plurality of peripheral devices by using the single standard protocol regardless of the types of the plurality of peripheral devices.

2. Discussion of the Background

Generally, in case of a modern computing device such as a personal computer (PC), a laptop, and a personal digital assistant (PDA), the computing devices are usually dependent on a data communication device, a modem which can enable communications through an interface such as a IEEE 802.11, a Code Division Multiple Access (CDMA), a General Packet Radio Service (GPRS), an Universal Mobile Telecommunications System (UMTS), etc.

Operating system (OS) being executed in such the computing devices usually supports, in order to perform data transmission and reception, a software application client such as a connection manager client using a communication capability provided by the data communication device.

The data communication device itself can provide the software applications being executed in the computing device with various services such as a network access service for accessing a network system state, a wireless data service for transceiving data through a wireless link, and a device management service for accessing a device identifier and a power level status.

Physically, communications between the computing device and the data communication device may be performed through a physical interconnection such as a serial bus including an USB, a RS-232, a PCI, and a PCMCIA and a wireless interface including a Bluetooth and an IEEE 802.11.

For upper layer communications between application clients being executed in the computing device and services being executed in the data communication device, that is, in case of client-service interface, protocols used in the conventional technologies may include an AT command set (defined for a W-CDMA 3GPP terminal in ‘AT command set for User Equipment (3GPP TS 27.007 V3.13.0 (2003)’ and defined for a CDMA 3GPP2 terminal in ‘Data Service Options for Spread Spectrum Systems: AT Command Processing and the Rm Interface (3GPP2 C.S0017-003-A)’), a Remote Network Drive Interface Specification (RNDIS), and a Universal Plug and Play (UPnP).

Currently, as the computing device supports the increased number of communication applications, the data communication device can support various communication technologies. For example, a laptop computer uses a modem supporting a Bluetooth, an IEEE 802.11, and a CDMA to execute communication applications such as a web browser, an e-mail, and a calendar synchronization.

Meanwhile, while a personal computer comprises various controllers for controlling external devices, and a main controller (e.g. a central processing unit (CPU)) can communicate with peripheral devices (or, external devices) through the various controllers, current embedded devices adopt a form of star-topology in which a main controller directly controls peripheral devices.

Here, the star-topology means a form in which a central main computer is connected to multiple small computer systems. In this topology, the small computer systems communicate with other computers through the central computer, and share a data base of the central computer. Also, since the central computer and all computer systems separated from the central computer are connected to the terminals, any terminal can communicate with other terminals in a communication network.

However, the configuration of the embedded devices according to the star-topology causes heavy load of the main controller (CPU) and more time, efforts, and costs for product commercialization. Especially, technical supports such as addition of registers for supporting various interfaces of various devices which can be connected to the main controller (CPU) should be provided. In addition, there may be disadvantage that continuous efforts are needed according to advents of various interfaces which are not standardized.

Especially, when a peripheral device or a peripheral bus which is not supported by an embedded System-On-a-Chip (SoC) is used, modification on the SoC or supplementary module should be used. In this case, due to the changed system, a further cost and verification time for added or modified hardware and software are needed.

### SUMMARY

The present invention is introduced in order to solve the above-described problems. An objective of the present invention is providing a data management system and method for controlling a plurality of peripheral devices by grouping them according to their characteristics, in which a data management device for managing data communications between a data control device and the plurality of peripheral devices is added between them, and the data management device controls the plurality of peripheral devices by grouping them according to their characteristics, whereby various protocols can be integrated into minimized optimal protocols by the grouping and the data control device can reduce technical and temporal overheads due to detection and control of the plurality of peripheral devices.

Another objective of the present invention is providing a data management system and a method for controlling a plurality of peripheral devices by virtualizing them, in which a data management device for managing data communications between a data control device and the plurality of peripheral devices is added between them, and the data management device virtualizes the plurality of peripheral devices requiring various interfacing manner as standard devices using a standard interfacing manner, whereby the data control device can control the plurality of peripheral devices by using the single standard protocol regardless of the types of the plurality of peripheral devices.

In order to achieve the objective of the present invention, a first aspect of the present invention may provide a data management system for controlling a plurality of peripheral devices, the system comprises a plurality of peripheral devices; a data control device for controlling input/output data of each of the plurality of peripheral devices; and a data management device connected between the plurality of peripheral devices and the data control device in order to manage data communications between them, wherein the data management device detects connection status of each of the plurality of peripheral devices, receives identification information of a detected peripheral device, and registers the detected peripheral device as an abstract peripheral device by describing characteristic information of the detected peripheral device based on a specification corresponding to a device group to which the detected peripheral device belongs according to a preconstructed device group data base, wherein the data management device generates description information for peripheral devices for each device group based on a list of the registered abstract peripheral devices, and transmits the description information to a corresponding data control device.

Here, the data management device comprises a data transceiving part transceiving data between the data control device and the plurality of peripheral devices; a device recognizing part detecting connection status of each of the plurality of peripheral devices, receiving identification information of the detected peripheral device, describing characteristic information of the detected peripheral device based on the specification corresponding to the device group to which the detected peripheral device belongs according to the device group data base, and transmitting the characteristic information; and a data management control part registering the detected peripheral device as the abstract peripheral device based on the characteristic information, generating the description information of peripheral devices for each device group based on the list of the registered abstract peripheral devices, and transmitting the generated description information of peripheral devices for each device group to the data control device in response to a request of the data control device.

Here, the description information of peripheral devices for each device group, generated in the data management control part, include information on the abstract peripheral devices such as at least one of device vendor information, device serial number information, and protocol information.

Here, the data management device and the data control device configure a packet according to a predefined protocol specification, and transmit the packet to each other through a communication channel using a single interface manner.

Here, the device group data base includes an inter-protocol packet conversion table which maps protocol interfaces defined for each of the plurality of peripheral devices onto standard protocol interfaces used by a corresponding device group.

Here, according to the description information, abstract peripheral devices belonging to a same device group communicate with each other by using same data formats, and abstract peripheral devices belonging to different device groups communicate with each other by using different data formats.

In order to achieve the objective of the present invention, a second aspect of the present invention may provide a data management method for efficient data communications for a system comprising a plurality of peripheral devices, a data control device controlling input/output data of the plurality of peripheral devices, and a data management device between them, the method comprises (a) detecting, at the data management device, connection status of each of the plurality of peripheral devices, receiving identification information of a detected peripheral device, and describing characteristic information of the detected peripheral device according to a specification demanded by a corresponding device group defined in a preconstructed device group database; (b) registering, at the data management device, the detected peripheral device as an abstract peripheral device based on the characteristic information, and generating description information of peripheral devices for each device group based on a list of registered abstract peripheral devices; and (c) transmitting, at the data management device, description information of peripheral devices for each device group to the data control device in response to a request of the data control device.

Here, the description information of peripheral devices for each device group, generated in the step (b), include information on the abstract peripheral devices such as at least one of device vendor information, device serial number information, and protocol information.

Here, the data management device and the data control device configure a packet according to a predefined protocol specification, and transmit the packet to each other through a communication channel using a single interface manner.

Here, in the step (a), the device group data base includes an inter-protocol packet conversion table which maps protocol interfaces defined for each of the plurality of peripheral devices onto standard protocol interfaces used by a corresponding device group.

Here, according to the description information generated in the step (b), abstract peripheral devices belonging to a same device group communicate with each other by using same data formats, and abstract peripheral devices belonging to different device groups communicate with each other by using different data formats.

In order to achieve the objective of the present invention, a third aspect of the present invention may provide a computer-readable medium on which program codes for the above-described data management method for controlling a plurality of peripheral devices by grouping them according to their characteristics are recorded.

The data management method for controlling a plurality of peripheral devices by grouping them according to their characteristics, according to the present invention, may be implemented as computer-readable program codes on a computer-readable medium. The computer-readable medium may include various storage devices in which data and program codes which a computer can read are stored.

For example, the computer-readable medium may include a ROM, a RAM, a CD-ROM, a magnetic table, a hard disc, a floppy disk, a removable storage device, a non-volatile memory (e.g. flash memory), an optical data storage device, etc.

In order to achieve the other objective of the present invention, a first aspect of the present invention may provide a data management system for controlling a plurality of peripheral devices, the system comprises a plurality of peripheral devices; a data management device detecting connection status of each of the plurality of peripheral devices, receiving identification information of the detected peripheral device, registering the detected peripheral device as an abstract peripheral device by describing characteristic information of the detected peripheral device based on a specification corresponding to a device group to which the detected peripheral device belongs, and generating description information of peripheral devices for each device group; and a data control device receiving the generated description information on peripheral devices for each device group from the data management device, identifying type and characteristics of the detected peripheral device by analyzing the description information according to specifications demanded by a corresponding device group, generating a virtual USB device virtualizing a physical connection to the detected peripheral device in order to make an operating system recognize the detected peripheral device as a standard USB device, and controlling operations of a USB driver 330 corresponding to the generated virtual USB device.

Here, the description information of peripheral devices for each device group, generated in the device management device, include information on the abstract peripheral devices such as at least one of device vendor information, device serial number information, and protocol information.

Here, the data management device and the data control device configure a packet according to a predefined protocol specification, and transmit the packet to each other through a communication channel using a single interface manner.

Here, according to the description information on peripheral devices for each device group generated in the data management device, abstract peripheral devices belonging to a same device group communicate with each other by using same data formats.

In order to achieve the other objective of the present invention, a second aspect of the present invention may provide a data management for efficient data communications for a system comprising a plurality of peripheral devices, a data control device controlling input/output data of the plurality of peripheral devices, and a data management device between them, the method comprises (a) receiving, at the data management device, identification information of a detected peripheral device whose connection is detected, and registering the detected peripheral device as an abstract peripheral device by describing characteristic information of the detected peripheral device based on a specification corresponding to a device group to which the detected peripheral device belongs; (b) generating, at the data control device, description information of peripheral devices for each device group based on a list of abstract peripheral devices registered in the step (a); (c) receiving, at the data control device, the description information on peripheral devices for each device group, and identifying type and characteristics of the peripheral device by analyzing the description information according to a specification demanded by the device group to which the detected peripheral device belongs; (d) generating, at the data control device, a virtual Universal Serial Bus (USB) device virtualizing a physical connection to the detected peripheral device in order to make an operating system recognize the detected peripheral device as a standard USB device; and (e) controlling, at the data control device, operations of a USB driver corresponding to the generated virtual USB device.

Here, the description information of peripheral devices for each device group, generated in the step (b), include information on the abstract peripheral devices such as at least one of device vendor information, device serial number information, and protocol information.

Here, the data management device and the data control device configure a packet according to a predefined protocol specification, and transmit the packet to each other through a communication channel using a single interface manner.

In order to achieve the other objective of the present invention, a third aspect of the present invention may provide a computer-readable medium on which program codes for the above-described data management method for controlling a plurality of peripheral devices by virtualizing them are recorded.

The data management method for controlling a plurality of peripheral devices by virtualizing them according to the present invention may be implemented as computer-readable program codes on a computer-readable medium. The computer-readable medium may include various storage devices in which data and program codes which a computer can read are stored.

For example, the computer-readable medium may include a ROM, a RAM, a CD-ROM, a magnetic table, a hard disc, a floppy disk, a removable storage device, a non-volatile memory (e.g. flash memory), an optical data storage device, etc.

### BRIEF DESCRIPTION OF THE DRAWINGS

FIG. 1 is a block diagram to explain a data management system for controlling a plurality of peripheral devices according to an example embodiment of the present invention;

FIG. 2 is a block diagram to explain a data management device applied to an example embodiment of the present invention;

FIG. 3 is a flow chart to explain a data management method for controlling a plurality of peripheral devices by grouping them based on their characteristics, according to an example embodiment of the present invention;

FIG. 4 is a detailed block diagram to explain a data management device and a data control device which are applied to an example embodiment of the present invention; and

FIG. 5 is a flow chart to explain a data management method for controlling a plurality of peripheral devices by virtualizing them, according to an example embodiment of the present invention.

### DETAILED DESCRIPTION OF THE ILLUSTRATED EMBODIMENTS

Example embodiments will now be described more fully hereinafter with reference to the accompanying drawings; however, they may be embodied in different forms and should not be construed as limited to the embodiment set forth herein. Rather, these example embodiments are provided so that this disclosure will be thorough ad complete, and will fully convey exemplary implementations to those skilled in the art. Like reference numerals in the drawings denote like or similar elements throughout the specification. The term ‘and/or’ may indicate each item and all combinations of the items.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present invention.

The terminology used herein is for the purpose of describing particular embodiments only and is not intended to be limiting of the embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, integers, steps, operations, elements, and/or components, but do not preclude the presence or addition of one or more other features, integers, steps, operations, elements, components, and/or groups thereof.

Unless defined otherwise, all technical and scientific terms used herein have the same meanings as commonly understood by one of ordinary skill in the art to which this invention belongs. Further, unless defined otherwise, all terms defined in generally used dictionaries may not be ideally or overly interpreted.

Also, when it is determined that the detailed description related to a related known function or configuration may make the purpose of the present invention unnecessarily ambiguous in describing the present invention, the detailed description will be omitted here.

All terms used herein are terms defined in consideration of their functions in example embodiments of the present invention. However, the terms may have different meanings according to an intention of one of ordinary skill in the art, precedent cases, or the appearance of new technologies. Thus, the terms used herein have to be defined based on the meaning of the terms together with the description throughout the specification.

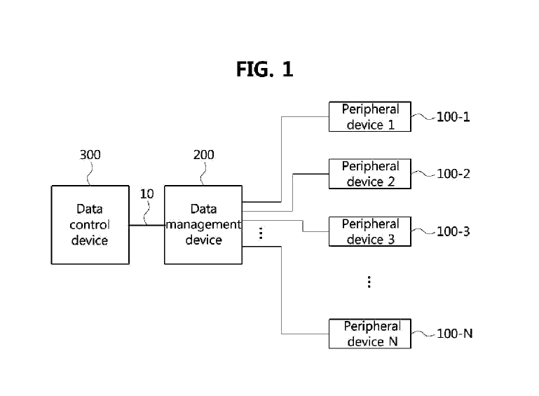

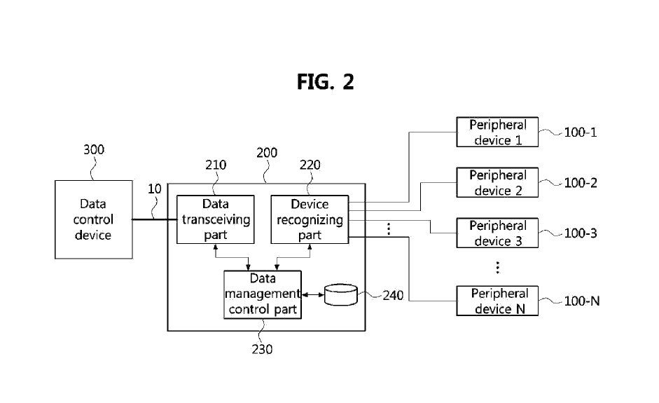

FIG. 1 is a block diagram to explain a data management system for controlling a plurality of peripheral devices according to an example embodiment of the present invention, and FIG. 2 is a block diagram to explain a data management device applied to an example embodiment of the present invention.

Referring to FIG. 1 and FIG. 2, a data management system for controlling a plurality of peripheral devices by grouping them according to their characteristics, according to an example embodiment of the present invention, may comprise a plurality of peripheral devices 100-1 to 100-N, a data management device 200, and a data control device 300, etc.

Here, the plurality of peripheral devices 100-1 to 100-N may include input/output devices except a central processing unit (CPU), secondary memory units, data communication devices for online systems, etc.

That is, for example, the plurality of peripheral devices for a smart phone may include components essential to a computer system such as a processor, a memory, a bus, etc. and components which are not essential to the computer system such as a Global Positioning System (GPS) module, a Code-Division Multiple Access (CDMA) communication module, a touch panel, a speaker, a microphone, etc.

Also, the plurality of peripheral devices may be referred to as ‘input/output devices’, and they may include devices providing or outputting some information to a main controller or a central processing unit (CPU), etc.

Meanwhile, peripheral devices such as a hard-disk, a CD-ROM drive, a network interface card, etc. may exist in a main body of the computer system together with principal components of the computer system. Otherwise, peripheral devices such as a printer, an image scanner, etc. may exist out of the main body of the computer system.

Also, the data management device 200 may be a bridge module performing a role of a communication mediator between the plurality of peripheral devices 100-1 to 100-N and the data control device 300, and comprise a physically-implemented chip and a firmware embedded in a chip memory. Such the data management device 200 may be upgraded for supports of new peripheral devices, bug fixing, performance enhancement, etc. by updating internal software.

Specifically, the data management device 200 detects connection status of each of the peripheral devices 100-1 to 100-N, receives identification information of the detected peripheral device, and registers the detected peripheral device as an abstract peripheral device by describing characteristic information of the detected peripheral device based on a specification corresponding to a device group to which the detected peripheral device belongs according to a preconstructed device group data base defining various device groups such as a network device groups (e.g. CDMA modem, GSM modem, LTE modem, etc.), an audio device group (e.g. microphone, speaker, etc.), a sensor device group, an input device group, etc.).

Here, the device group data base 240 may include determination criteria used for determining which device group each of the plurality of peripheral devices 100-1 to 100-N belongs to, and inter-protocol packet conversion table which maps protocol interfaces defined for each of the plurality of peripheral devices 100-1 to 100-N onto standard protocol interfaces used by a corresponding device group.

Also, the data management device 200 generates description information of peripheral devices for each device group based on a list of the registered abstract peripheral devices, and transmits the generated description information of peripheral devices for each device group to the data control device 300 in response to a request of the data control device 300.

Meanwhile, according to the description information on peripheral devices for each device group, it is desirable that abstract peripheral devices belonging to the same device group communicate with each other by using the same data format and communication manner and that the abstract peripheral devices belonging to different device groups communicate with each other by using different data format and communication manner.

As shown in FIG. 2, the data management device 200 may comprise a data transceiving part 210 transceiving data between the data control device 300 and the plurality of peripheral devices 100-1 to 100-N; a device recognizing part 220 detecting connection status of each of the plurality of peripheral devices 100-1 to 100-N, receiving identification information of the detected peripheral device, describing characteristic information of the detected peripheral device based on a specification corresponding to a device group to which the detected peripheral device belongs according to a preconstructed device group data base 240, and transmitting the characteristic information; and a data management control part 230 registering the detected peripheral device as an abstract peripheral device based on the characteristic information, generating description information of peripheral devices for each device group based on a list of the registered abstract peripheral devices, and transmitting the generated description information of peripheral devices for each device group to the data control device 300 in response to a request of the data control device 300.

Also, it is desirable that the description information of peripheral devices for each device group, generated in the data management control part 230, include information on the abstract peripheral devices such as at least one of device vendor (manufacturer) information, device serial number information, and protocol information.

Also, the data transceiving part 210 and/or the data management control part 230 of the data management device 200 may perform verification on validity (e.g. noise or packet loss) of data received through a wired or wireless communication channel 10, which is connected to the data control device 300, such as USB, 1394, WiFi, NIC, LTE, CDMA, and GSM.

Also, it is desirable that the data transceiving part 210 of the data management device 200 configures and transfers a packet according to a protocol specified as a standard.

Also, the data control device 300 is a device which is connected to the data management device 200 through a wired or wireless communication channel 10, and controls input/output data of each of the plurality of peripheral devices 100-1 to 100-N. For example, it may be a central processing unit (CPU) of a desktop computer or an application processor (AP) of an embedded device, which processes and responds to instructions for system operations. In addition, it performs a role of a core device controlling various peripheral devices connected to the system.

In this case, it is desirable that the communication channel 10 is configured with a wired or wireless communication such as a Universal Serial Bus (USB) communication, a 1394 bus communication, a WiFi communication, a Network Interface Card (NIC) communication, a Long Term Evolution (LTE) communication, a Global System for mobile communication (GSM), and a Code-Division Multiple Access (CDMA), etc. However, the communication channel 10 may not be restricted to the above examples, and may be configured with any kind of wired or wireless communication, an internet, etc.

Here, the internet means a TCP/IP protocol layer and a world-wide open type network structure providing various services over the layer such as Hyper Text Transfer Protocol (HTTP), Telnet, File Transfer Protocol (FTP), Domain Name System (DNS), Simple Mail Transfer Protocol (SMTP), Simple Network Management Protocol (SNMP), Network File Service (NFS), Network Information Service (NIS), etc., and provides an environment through which the data management device 200 can access the data control device 300. On the other hand, the internet may be provided as a wired internet or a wireless internet, or may be provided as a core network in which a wired public network, a wireless mobile network, or a portable internet are combined.

Meanwhile, the data management device 200 and the data control device 300 can configure a packet according to a predefined protocol specification, and transfer the packet to each other through the wired or wireless communication channel 10 configured with a single interface manner.

Meanwhile, the above-described data management system for controlling a plurality of peripheral devices by grouping them according to their characteristics, according to an example embodiment of the present invention, for example, may have advantages which can increase competitiveness of products when it is applied to the multi-function products such as a smart phone, a tablet PC, a home network system, and the like.

Hereinafter, the above-described method for data management for controlling a plurality of peripheral devices by grouping them according to their characteristics, according to an example embodiment of the present invention, will be explained in further detail.

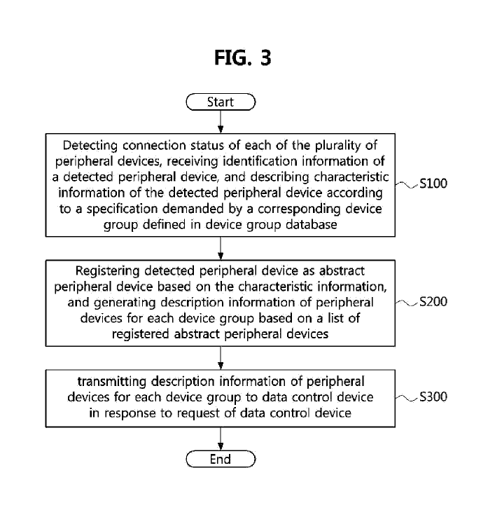

FIG. 3 is a flow chart to explain a data management method for controlling a plurality of peripheral devices by grouping them based on their characteristics, according to an example embodiment of the present invention.

Referring to FIGS. 1 to 3, in the data management method according to an example embodiment of the present invention, first, the data management device 200 detects connection status of each of the plurality of peripheral devices 100-1 to 100-N, receives identification information of the detected peripheral device, and describes characteristic information of the detected peripheral device based on a specification corresponding to a device group to which the detected peripheral device belongs according to a preconstructed device group data base 240 (S100).

Here, in the step S100, it is desirable for the device group data base 240 to include the inter-protocol packet conversion table which maps protocol interfaces defined for each of the plurality of peripheral devices 100-1 to 100-N onto standard protocol interfaces used by a corresponding device group.

Then, the device management device 200 registers the detected peripheral device as an abstract peripheral device based on the characteristic information described in the step S100, and generates description information of peripheral devices for each device group based on a list of the registered abstract peripheral devices (S200).

Here, it is desirable for the description information generated in step S200 to include information on the abstract peripheral devices such as at least one of device vendor (manufacturer) information, device serial number information, and protocol information.

Meanwhile, according to the description information generated in the step S200, it is desirable that abstract peripheral devices belonging to the same device group communicate with each other by using the same data format and communication manner and that the abstract peripheral devices belonging to different device groups communicate with each other by using different data format and communication manner.

After then, the data management device 200 transmits the generated description information of peripheral devices for each device group to the data control device 300 in response to a request of the data control device 300 (S300).

Here, the data management device 200 and the data control device 300 can configure a packet according to a predefined protocol specification, and transfer the packet to each other through the wired or wireless communication channel 10 configured with a single interface manner.

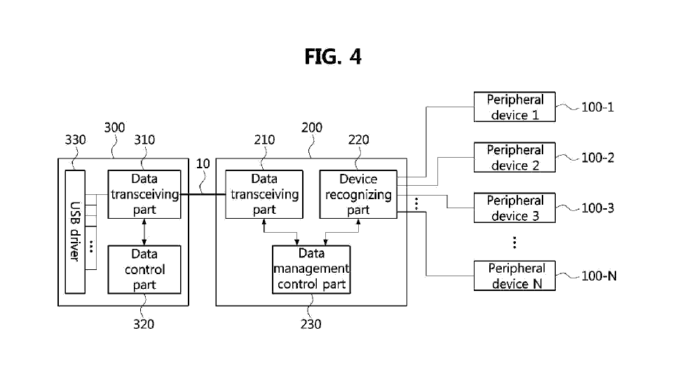

FIG. 4 is a detailed block diagram to explain a data management device and a data control device which are applied to an example embodiment of the present invention.

Referring to FIG. 1 and FIG. 4, the data management system for controlling a plurality of peripheral devices by virtualizing them, according to an example embodiment of the present invention, may comprise a plurality of peripheral devices 100-1 to 100-N, a data management device 200, and a data control device 300, etc.

Here, the plurality of peripheral devices 100-1 to 100-N may include input/output devices except a central processing unit (CPU), secondary memory units, data communication devices for online systems, etc.

That is, for example, a plurality of peripheral devices for a smart phone may include components essential to a computer system such as a processor, a memory, a bus, etc. and components which are not essential to the computer system such as a Global Positioning System (GPS) module, a Code-Division Multiple Access (CDMA) communication module, a touch panel, a speaker, a microphone, etc.

Also, the plurality of peripheral devices may be referred to as ‘input/output devices’, and they may include devices providing or outputting some information to a main controller or a central processing unit (CPU), etc.

Meanwhile, peripheral devices such as a hard-disk, a CD-ROM drive, a network interface card, etc. may exist in a main body of the computer system together with principal components of the computer system. Otherwise, peripheral devices such as a printer, an image scanner, etc. may exist out of the main body of the computer system.

Also, the data management device 200 may be a bridge module performing a role of a communication mediator between the plurality of peripheral devices 100-1 to 100-N and the data control device, and comprise a physically-implemented chip and a firmware embedded in a chip memory. Such the data management device 220 may be upgraded for supports of new peripheral devices, bug fixing, performance enhancement, etc. by updating internal software.

Here, the data management device 200 performs a function of detecting connection status of each of the plurality of peripheral devices 100-1 to 100-N, receiving identification information of the detected peripheral device, registering the detected peripheral device as an abstract peripheral device by describing characteristic information of the detected peripheral device based on a specification corresponding to a device group to which the detected peripheral device belongs, and generating description information of peripheral devices for each device group.

Here, the device group to which each of the plurality of peripheral devices 100-1 to 100-N belongs may be determined according to its characteristic, and include a network device groups (e.g. CDMA modem, GSM modem, LTE modem, etc.), an audio device group (e.g. microphone, speaker, etc.), a sensor device group, an input device group, etc.

Meanwhile, according to the description information on peripheral devices for each device group, which is generated in the data management device 200, it is desirable that abstract peripheral devices belonging to the same device group communicate with each other by using the same data format and communication manner.

As shown in FIG. 2, the data management device 200 may comprise a data transceiving part 210 transceiving data between the data control device 300 and the plurality of peripheral devices 100-1 to 100-N; a device recognizing part 220 detecting connection status of each of the plurality of peripheral devices 100-1 to 100-N, receiving identification information of the detected peripheral device, describing characteristic information of the detected peripheral device based on a specification corresponding to a device group to which the detected peripheral device belongs according to a preconstructed device group data base 240, and transmitting the characteristic information; and a data management control part 230 registering the detected peripheral device as an abstract peripheral device based on the characteristic information, generating description information of peripheral devices for each device group based on a list of the registered abstract peripheral devices, and transmitting the generated description information of peripheral devices for each device group to the data control device 300 in response to a request of the data control device 300.

Also, it is desirable that the description information of peripheral devices for each device group, generated in the data management control part 230, include information on the abstract peripheral devices such as at least one of device vendor (manufacturer) information, device serial number information, and protocol information.

Also, the data transceiving part 210 and/or the data management control part 230 of the data management device 200 may perform verification on validity (e.g. noise or packet loss) of data received through a wired or wireless communication channel 10, which is connected to the data control device 300, such as USB, 1394, WiFi, NIC, LTE, CDMA, and GSM.

Also, it is desirable that the data transceiving part 210 of the data management device 200 configures and transfers a packet according to a protocol specified as a standard.

Also, the data control device 300 is a device which is connected to the data management device 200 through a wired or wireless communication channel 10, and controls input/output data of each of the plurality of peripheral devices 100-1 to 100-N. For example, it may be a central processing unit (CPU) of a desktop computer or an application processor (AP) of an embedded device, which processes and responds to instructions for system operations. In addition, it performs a role of a core device controlling various peripheral devices connected to the system.

In this case, it is desirable that the communication channel 10 is configured with a wired or wireless communication such as a Universal Serial Bus (USB) communication, a 1394 bus communication, a WiFi communication, a Network Interface Card (NIC) communication, a Long Term Evolution (LTE) communication, a Global System for mobile communication (GSM), and a Code-Division Multiple Access (CDMA), etc. However, the communication channel 10 may not be restricted to the above examples, and may be configured with any kind of wired or wireless communication, an internet, etc.

Here, the internet means a TCP/IP protocol layer and a world-wide open type network structure providing various services over the layer such as Hyper Text Transfer Protocol (HTTP), Telnet, File Transfer Protocol (FTP), Domain Name System (DNS), Simple Mail Transfer Protocol (SMTP), Simple Network Management Protocol (SNMP), Network File Service (NFS), Network Information Service (NIS), etc., and provides an environment through which the data management device 200 can access the data control device 300. On the other hand, the internet may be provided as a wired internet or a wireless internet, or may be provided as a core network in which a wired public network, a wireless mobile network, or a portable internet are combined.

Specifically, the data control device 300 receives the generated description information on peripheral devices for each device group from the data management device 200, identifies type and characteristics of each peripheral device by analyzing the description information according to specifications demanded by a corresponding device group, generates a virtual Universal Serial Bus (USB) device virtualizing a physical connection to the peripheral device in order to make an operating system recognize the peripheral device as a standard USB device, and controls operations of a USB driver 330 corresponding to the generated virtual USB device.

Here, the USB driver 330 may be a kind of program which can be used for a program having a level identical to that of the application program to interwork with a hardware device. That is, the USB driver 330 acts as a kind of mediator which gives a command to a hardware device and receives data in response to the command from the hardware device. The USB driver 330 exchanges data with the peripheral devices 100-1 to 100-N by using a bus connected physically to the peripheral devices 100-1 to 100-N and a lower-level communication system.

Meanwhile, the application program, for example, may be an application program having a specific purpose such as a Microsoft Word, a Microsoft Excel, a Hangeul word processor, a game, etc. Generally, the application program 400 uses resources of the peripheral devices 100-1 to 100-N. For example, a word processor application uses a keyboard and a mouse, and a video player application uses a display device and a speaker device.

As shown in FIG. 4, the data control device 300 may comprise a data transceiving part 310 transceiving data between the data control device 300 and the data management device 200; and a data control part 320 receiving the generated description information on peripheral devices for each device group from the data management device 200 through the data transceiving part 310, identifying type and characteristics of each peripheral device by analyzing the description information according to specifications demanded by a corresponding device group, generating a virtual USB device virtualizing a physical connection to the detected peripheral device in order to make an operating system recognize the detected peripheral device as a standard USB device, and controlling operations of a USB driver 330 corresponding to the generated virtual USB device.

Also, the data transceiving part 310 and/or the data control part 320 of the data control device 300 may perform verification on validity (e.g. noise or packet loss) of data received through a wired or wireless communication channel 10, which is connected to the data management device 200.

Also, it is desirable that the data transceiving part 310 of the data control device 300 configures and transfers a packet according to a protocol specified as a standard.

That is, the data management device 200 and the data control device 300 can configure a packet according to a predefined protocol specification, and transfer the packet to each other through the wired or wireless communication channel 10 configured with a single interface manner.

Meanwhile, it is desirable that each of the data management device 200 and the device control device 300 equips a wired or wireless communication module (not illustrated) for performing data communications through the wired or wireless communication channel 10.

Meanwhile, the above-described data management system for controlling a plurality of peripheral devices by virtualizing them, according to an example embodiment of the present invention, for example, may have advantages that it can provide various cost savings and product competitiveness when it is applied to an embedded device implementing multi-functions in an environment where function expansion is not easy, such as a smart phone, a machine-to-machine (M2M) device, a tablet PC, a navigation, a home network system, etc.

Hereinafter, a data management method for controlling a plurality of peripheral devices by virtualizing them, according to an example embodiment of the present invention, will be explained in further detail.

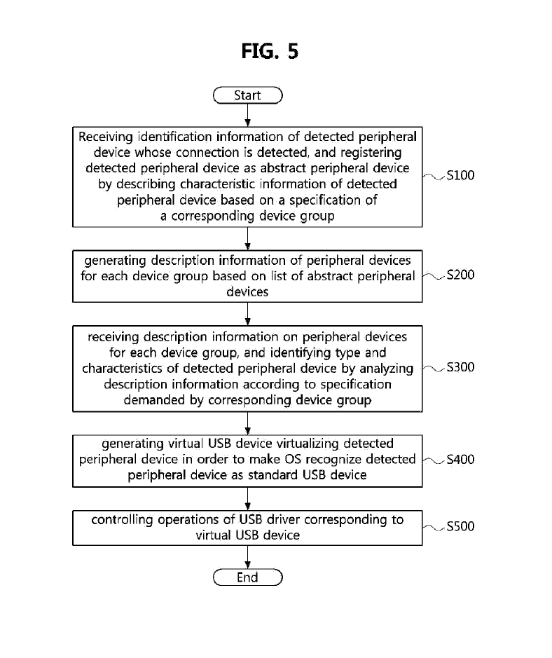

FIG. 5 is a flow chart to explain a data management method for controlling a plurality of peripheral devices by virtualizing them according to an example embodiment of the present invention.

Referring to FIGS. 1, 4, and 5, in a data management method for controlling a plurality of peripheral devices by virtualizing them, according to an example embodiment of the present invention, the data management device 200 detects connection status of each of the plurality of peripheral devices, receives identification information of the detected peripheral device, registers the detected peripheral device as an abstract peripheral device by describing characteristic information of the detected peripheral device based on a specification corresponding to a device group to which the detected peripheral device belongs (S100).

Then, the data management device 200 generates description information of peripheral devices for each device group based on a list of abstract peripheral devices registered in the step S100 (S200).

Here, it is desirable that the description information of peripheral devices for each device group, generated in the step S200, include detailed information on the abstract peripheral devices such as at least one of device vendor (manufacturer) information, device serial number information, and protocol information.

Then, the data control device 300 receives the description information on peripheral devices for each device group, and identifies type and characteristics of the peripheral device by analyzing the description information according to a specification demanded by the device group to which the detected peripheral device belongs (S300).

After then, the data control device 300 generates a virtual USB device virtualizing a physical connection to the detected peripheral device in order to make an operating system recognize the detected peripheral device as a standard USB device (S400).

After then, the data control device 300 controls operations of a USB driver corresponding to the generated virtual USB device.

Meanwhile, the data management method according to the present invention may also be implemented as program codes on a computer-readable medium which a computer can read. The computer-readable medium may include various storage devices in which data and program codes which a computer can read are stored.

For example, the computer-readable medium may include a ROM, a RAM, a CD-ROM, a magnetic table, a hard disc, a floppy disk, a removable storage device, a non-volatile memory (e.g. flash memory), an optical data storage device, etc. Also, the computer-readable medium may be distributed on computer systems connected through a computer communication network, and the program codes may be stored thereon as codes which can be read in distributed manner.

According to the above-described data management system and method for controlling a plurality of peripheral devices by grouping them according to their characteristics, the data management device for managing data communications between a data control device and the plurality of peripheral devices is added between them, and the data management device controls the plurality of peripheral devices by grouping them according to their characteristics, whereby various protocols can be integrated into minimized optimal protocols by the grouping and the data control device can innovatively reduce technical and temporal overheads due to detection and control of the plurality of peripheral devices.

Also, according to the above-described data management system and method for controlling a plurality of peripheral devices by virtualizing them, the data management device for managing data communications between a data control device and the plurality of peripheral devices is added between them, and the data management device virtualizes the plurality of peripheral devices requiring various interfacing manner as standard devices using a standard interfacing manner, whereby the data control device can control the plurality of peripheral devices by using the single standard protocol regardless of the types of the plurality of peripheral devices.

Also, according to the present invention, the data management device for managing data communications between a data control device and the plurality of peripheral devices is added between them, and the data management can make it possible that the data control device controls peripheral devices by using a single unified protocol, whereby costs for interworking can be minimized, and stability and extensibility of the products can be enhanced. Also, the data control device can innovatively reduce technical and temporal overheads due to detection and control of the plurality of peripheral devices.

Also, according to the present invention, the data management device for managing data communications between a data control device and the plurality of peripheral devices is added between them. Thus, load of the data control device can be reduced, and costs such as time, technologies, etc. for product commercialization can be innovatively reduced. Also, easiness of product development due to the present invention may cause decrease of product unit price, whereby customers can buy the products having equal quality with less expense.

Also, according to the present invention, the present invention may be applied to an embedded device implementing multi-functions such as a smart phone, a machine-to-machine (M2M) device, a tablet PC, a home network system, etc., thereby enhancing competitiveness of the products. Thus, the present invention can make development and production of multi-function devices easy, and lower market entry barriers, whereby small-sized companies having poor peripheral device interoperation techniques can more easily enter into new market, and related markets can rev up.

Also, according to the present invention, a standard USB device which most of OS systems support is generated virtually, whereby a basically installed USB driver can be utilized. Therefore, users do not have to install additional device drivers in order to user peripheral devices, so that they are free from dangers which can be caused by wrong device driver installations. Also, development and compatibility burdens of peripheral device vendors and data control device vendors may be lessened.

While the example embodiments of the present invention and their advantages have been described in detail, it should be understood that various changes, substitutions and alterations may be made herein without departing from the scope of the invention.

1. A data management system for controlling a plurality of peripheral devices, the system comprising:
a plurality of peripheral devices;
a data control device for controlling input/output data of each of the plurality of peripheral devices; and
a data management device connected between the plurality of peripheral devices and the data control device in order to manage data communications between them,
wherein the data management device detects connection status of each of the plurality of peripheral devices, receives identification information of a detected peripheral device, and registers the detected peripheral device as an abstract peripheral device by describing characteristic information of the detected peripheral device based on a specification corresponding to a device group to which the detected peripheral device belongs according to a preconstructed device group data base,
wherein the data management device generates description information for peripheral devices for each device group based on a list of the registered abstract peripheral devices, and transmits the description information to a corresponding data control device.

2. The system of claim 1, wherein the data management device comprises
a data transceiving part transceiving data between the data control device and the plurality of peripheral devices;
a device recognizing part detecting connection status of each of the plurality of peripheral devices, receiving identification information of the detected peripheral device, describing characteristic information of the detected peripheral device based on the specification corresponding to the device group to which the detected peripheral device belongs according to the device group data base, and transmitting the characteristic information; and
a data management control part registering the detected peripheral device as the abstract peripheral device based on the characteristic information, generating the description information of peripheral devices for each device group based on the list of the registered abstract peripheral devices, and transmitting the generated description information of peripheral devices for each device group to the data control device in response to a request of the data control device.

3. The system of claim 1, wherein the description information of peripheral devices for each device group, generated in the data management control part, include information on the abstract peripheral devices such as at least one of device vendor information, device serial number information, and protocol information.

4. The system of claim 1, wherein the data management device and the data control device configure a packet according to a predefined protocol specification, and transmit the packet to each other through a communication channel using a single interface manner.

5. The system of claim 1, wherein the device group data base includes an inter-protocol packet conversion table which maps protocol interfaces defined for each of the plurality of peripheral devices onto standard protocol interfaces used by a corresponding device group.

6. The system of claim 1, wherein, according to the description information, abstract peripheral devices belonging to a same device group communicate with each other by using same data formats, and abstract peripheral devices belonging to different device groups communicate with each other by using different data formats.

7. A data management method for efficient data communications for a system comprising a plurality of peripheral devices, a data control device controlling input/output data of the plurality of peripheral devices, and a data management device between them, the method comprising:
(a) detecting, at the data management device, connection status of each of the plurality of peripheral devices, receiving identification information of a detected peripheral device, and describing characteristic information of the detected peripheral device according to a specification demanded by a corresponding device group defined in a preconstructed device group database;
(b) registering, at the data management device, the detected peripheral device as an abstract peripheral device based on the characteristic information, and generating description information of peripheral devices for each device group based on a list of registered abstract peripheral devices; and
(c) transmitting, at the data management device, description information of peripheral devices for each device group to the data control device in response to a request of the data control device.

8. The method of claim 7, wherein the description information of peripheral devices for each device group, generated in the step (b), include information on the abstract peripheral devices such as at least one of device vendor information, device serial number information, and protocol information.

9. The method of claim 7, wherein the data management device and the data control device configure a packet according to a predefined protocol specification, and transmit the packet to each other through a communication channel using a single interface manner.

10. The method of claim 7, wherein, in the step (a), the device group data base includes an inter-protocol packet conversion table which maps protocol interfaces defined for each of the plurality of peripheral devices onto standard protocol interfaces used by a corresponding device group.

11. The method of claim 7, wherein, according to the description information generated in the step (b), abstract peripheral devices belonging to a same device group communicate with each other by using same data formats, and abstract peripheral devices belonging to different device groups communicate with each other by using different data formats.

12. A data management system for controlling a plurality of peripheral devices, the system comprising:
a plurality of peripheral devices;
a data management device detecting connection status of each of the plurality of peripheral devices, receiving identification information of the detected peripheral device, registering the detected peripheral device as an abstract peripheral device by describing characteristic information of the detected peripheral device based on a specification corresponding to a device group to which the detected peripheral device belongs, and generating description information of peripheral devices for each device group; and
a data control device receiving the generated description information on peripheral devices for each device group from the data management device, identifying type and characteristics of the detected peripheral device by analyzing the description information according to specifications demanded by a corresponding device group, generating a virtual USB device virtualizing a physical connection to the detected peripheral device in order to make an operating system recognize the detected peripheral device as a standard USB device, and controlling operations of a USB driver 330 corresponding to the generated virtual USB device.

13. The system of claim 12, wherein the description information of peripheral devices for each device group, generated in the device management device, include information on the abstract peripheral devices such as at least one of device vendor information, device serial number information, and protocol information.

14. The system of claim 12, wherein the data management device and the data control device configure a packet according to a predefined protocol specification, and transmit the packet to each other through a communication channel using a single interface manner.

15. The system of claim 12, wherein, according to the description information on peripheral devices for each device group generated in the data management device, abstract peripheral devices belonging to a same device group communicate with each other by using same data formats.

16. A data management for efficient data communications for a system comprising a plurality of peripheral devices, a data control device controlling input/output data of the plurality of peripheral devices, and a data management device between them, the method comprising:
(a) receiving, at the data management device, identification information of a detected peripheral device whose connection is detected, and registering the detected peripheral device as an abstract peripheral device by describing characteristic information of the detected peripheral device based on a specification corresponding to a device group to which the detected peripheral device belongs;
(b) generating, at the data control device, description information of peripheral devices for each device group based on a list of abstract peripheral devices registered in the step (a);
(c) receiving, at the data control device, the description information on peripheral devices for each device group, and identifying type and characteristics of the peripheral device by analyzing the description information according to a specification demanded by the device group to which the detected peripheral device belongs;
(d) generating, at the data control device, a virtual Universal Serial Bus (USB) device virtualizing a physical connection to the detected peripheral device in order to make an operating system recognize the detected peripheral device as a standard USB device; and
(e) controlling, at the data control device, operations of a USB driver corresponding to the generated virtual USB device.

17. The method of claim 16, wherein the description information of peripheral devices for each device group, generated in the step (b), include information on the abstract peripheral devices such as at least one of device vendor information, device serial number information, and protocol information.

18. The method of claim 16, wherein the data management device and the data control device configure a packet according to a predefined protocol specification, and transmit the packet to each other through a communication channel using a single interface manner.
